(19) United States
(12) Patent Application Publication
(10) Pub. No.: US 2014/0278749 A1
(43) Pub. Date: Sep. 18, 2014

(54) METHOD AND APPARATUS FOR DETERMINING WEBSITE POLARIZATION AND FOR CLASSIFYING POLARIZED VIEWERS ACCORDING TO VIEWER BEHAVIOR WITH RESPECT TO POLARIZED WEBSITES

(71) Applicant: TubeMogul, Inc., Emeryville, CA (US)

(72) Inventors: John M. TRENKLE, Albany, CA (US); John HUGHES, Lafayette, CA (US)

(73) Assignee: TubeMogul, Inc., Emeryville, CA (US)

(21) Appl. No.: 13/927,687

(22) Filed: Jun. 26, 2013

Related U.S. Application Data
(60) Provisional application No. 61/779,270, filed on Mar. 13, 2013.
(60) Provisional application No. 61/779,231, filed on Mar. 13, 2013.

(51) Int. Cl. G06Q 30/02

(52) U.S. Cl. CPC G06Q 30/0201
USPC 705/7.29

(57) ABSTRACT

Websites and viewers are characterized for online advertising media campaigns, enabling online bidding capabilities for media campaigns, including pricing based on delivered Gross Rating Points (GRPs) instead of delivered impressions. GRPs for a campaign are estimated based on characterizing polarized Websites and then characterizing polarized viewers. A truth set of viewers having known characteristics is established and then compared with historic and current media viewing activity to determine a degree of polarity for different Media Properties (MPs), such as Websites offering ads, with respect to viewer characteristics such as gender and age bias. A broader base of polarized viewers is then characterized for age and gender bias, and their propensity to visit a polarized MP is rated. Based on observed and calculated parameters, bidding functionalities are enabled, including predicting a GRP total and pricing GRPs to a client and/or advertiser for an online ad campaign.

### CROSS REFERENCE TO RELATED APPLICATIONS

This application claims priority to U.S. provisional patent application Ser. No. 61/779,270, filed Mar. 13, 2013, and U.S. provisional patent application Ser. No. 61/779,231, filed Mar. 13, 2013, each of which is incorporated herein in its entirety by this reference thereto.

### BACKGROUND OF THE INVENTION

### Technical Field

The invention relates to rating the success of online advertising campaigns, as well as predicting the success of online advertising campaigns, and pricing campaigns based on the predictions. More particularly, the invention relates to characterizing viewer behavior and determining the degree to which a specific viewer's behavior places that viewer in a specific category with respect to their behavior, wherein such viewer is deemed to be a polarized viewer; and the invention also relates to characterizing Websites with respect to polarized characteristics.

### Description of the Background Art

Gross Rating Point (GRP) is a term used in advertising to measure the size of an audience reached by a specific media vehicle or schedule. It is the product of the percentage of the target audience reached by an advertisement, times the frequency the audience sees the term in a given campaign (frequency×% reached). For example, a television advertisement that is aired five times reaching 50% of the target audience each time it is aired would have a GRP of 250 (5×50%). To achieve a common denominator and compare media, reach x frequency are expressed over time (divided by time) to determine the weight of a media campaign. GRP's are used predominantly as a measure of media with high potential exposures or impressions, such as outdoor, broadcast, or online, e.g. the Internet.

GRP values are commonly used by media buyers to compare the advertising strength of various media vehicles, including in recent years, online advertising on the Internet. All GRP calculations to date are historical, being compiled after a campaign completes. Video ads typically contain a pixel pattern referred to as a tracking pixel that is supported by, for instance, Nielsen. For example, if a user logs onto Facebook (a Nielsen media partner) and then visits another Website where an ad that Nielsen is tracking is shown, Nielsen puts a pixel in the ad that prompts Facebook to send Nielsen the age and gender of the people who viewed the ad. Nielsen can then match the IP address of the pixel to see if the person is also on a Nielsen panel. If so, the information from the third-party partner can be combined with the panel demographics. This mechanism enables Nielsen to report on the GRPs delivered on a specific online ad campaign after the campaign has completed.

In a RTB (Real-Time Bidding) environment for electronic media impression auctions, an electronic advertising agency and/or consolidator operating a demand-side platform receives billions of daily auction opportunities for electronic media impressions from partners such as Google, Yahoo, etc. These partners operate auctions for ad impressions and then place electronic ads based on the auction results. A partner's auction is considered to be an external auction with respect to a demand-side platform, where an internal auction may also be operated to determine which advertisements, also referred to herein as ads, and bids are submitted to the external auction. Each ad impression opportunity includes information parameters about the ad impression, for example, the target website, geolocation of the user, ad size, user cookie, etc., that are used for targeting purposes. The demand side platform then processes hundreds of ads in their system, supplied by advertiser clients along with desired filtering and/or targeting parameters, against information parameters supplied by the partner, and filters out any ads that do not qualify, e.g. the advertiser does not want to target youtube. For ads that are not removed due to a mismatch with targeting parameters, the demand-side platform then evaluates the corresponding bids that represent how much each client advertiser is willing to pay. The winning bid in the internal auction is then sent to the external auction to compete for the impression opportunity.

Because electronic advertising agencies and/or consolidators that operate a demand-side platform have not previously been known to guarantee the reach of a campaign ahead of time, they typically charge their advertisers and/or clients based on impressions at a guaranteed price per impression after the fact, and without guaranteeing that those impressions are on target with respect to specific viewer characteristics. In some scenarios, the electronic advertising agency and/or consolidator that operates a demand-side platform and the advertiser and/or client may in fact be the same entity, e.g. when they comprise a large organization with an internal advertising department that is capable of acting as a demand-side platform. Also, in such an instance, there may be no internal auction, but just a submission to an external auction.

### SUMMARY OF THE INVENTION

Embodiments of the invention characterize Websites and viewers, thereby forming a foundation for the prediction of Gross Rating Points (GRPs) for online advertising media campaigns, as well as for other functionalities related to real-time bidding for electronic media impression auctions. To enable prediction of GRPs for a campaign, polarized Websites are characterized and then polarized viewers are characterized. To accomplish this, a truth set of viewers having known characteristics is established and then compared with historic and current media viewing activity to determine a degree of polarity for different Media Properties (MPs), e.g. typically Websites offering ads, with respect to gender and age bias. A broader base of polarized viewers is then characterized for age and gender bias, and their propensity to visit a polarized MP is rated. Based on observed and calculated parameters, a GRP total can then be predicted and priced to a client and/or advertiser for an online ad campaign

### BRIEF DESCRIPTION OF THE DRAWINGS

FIG. 1 is a block diagram showing system components and data flow for a demand side platform according to the invention;

FIG. 2 is a block diagram showing system components and data flow for Website and viewer polarization profiling and GRP prediction and quoting according to the invention;

FIG. 3 is a flowchart showing determination of site polarization and determination of polarization for unknown viewers to classify them as known polarized viewers according to the invention; and

FIG. 4 is a block schematic diagram showing a machine in the exemplary form of a computer system within which a set of instructions for causing the machine to perform any of the herein disclosed methodologies may be executed.

### DETAILED DESCRIPTION OF THE INVENTION

Embodiments of the invention characterize Websites and viewers, thereby forming a foundation for the prediction of Gross Rating Points (GRPs) for online advertising media campaigns, as well as for other functionalities related to real-time bidding for electronic media impression auctions. To enable prediction of GRPs for a campaign, polarized Websites are characterized and then polarized viewers are characterized. To accomplish this, a truth set of viewers having known characteristics is established and then compared with historic and current media viewing activity to determine a degree of polarity for different Media Properties (MPs), e.g. typically Websites offering ads, with respect to gender and age bias. A broader base of polarized viewers is then characterized for age and gender bias, and their propensity to visit a polarized MP is rated. Based on observed and calculated parameters, a GRP total can then be predicted and priced to a client and/or advertiser for an online ad campaign.

Where a polarization profile for a specific viewer is not known it is still useful to understand the polarization profile or probability for a Website, e.g. when that viewer is about to be offered an ad impression. A GRP expectation can be computed for such scenarios based on the knowledge that the polarization of a particular Website being visited is aligned with targeting for an online ad campaign. Further, a database that contains polarized Websites that have each been profiled according to their polarization probabilities with respect to certain Viewer Characteristics (VCs) is not only useful in estimating GRPs for a campaign, but it is also useful for profiling unknown viewers to classify them and create a database of polarized viewers.

### Profiling Polarization of Media Properties

A key function of the processes described herein is to determine the polarization of a Media Property (MP). An MP represents a specific instance of a media platform for electronically delivering information to a viewer. An MP as referenced herein usually refers to a Website or URL on the Internet, however an MP may also refer to, e.g. an App ID, a Game ID, or other electronic media, including for example electronic billboards. Polarization in general refers to the extent that a particular MP, or as will later be described, a particular viewer, has characteristics that are biased or not biased with respect to certain targeting criteria. Polarization ratings are usually expressed in terms of probability percentages, although other rating methods may be used. The targeting characteristics that are most commonly used for polarity rating include age and gender, although other characteristics may be also rated. Viewer age is typically broken down into age brackets, for example 12-17, 18-34, 35-44, etc. Viewers are commonly identified by an electronic cookie passed from their computer to a site that they are visiting and, as such, the process for classification of viewers according to various viewer characteristics is sometimes referred to as cookie bucketing. A particular viewer may in fact use multiple computers and, therefore, have multiple cookies. While multiple cookies may typically treated as multiple viewers, it is possible to treat them as the same viewer if sufficient information on a viewer and the viewer's computer use is known. For purposes of the discussion herein, each cookie is assumed to represent a different viewer and the terms viewer and cookie are assumed to be synonymous.

FIG. 1 is a block diagram that shows system components and data flow for a demand side platform according to the invention. In FIG. 1, there is a focus on information conveyed relative to polarization profiling of MPs and viewers, and for estimating and quoting Gross Rating Points (GRPs) to an advertiser client 116 provided by a demand-side platform 114. GRP estimation according to the invention includes first establishing databases of referred to as polarized MPs, as well as a database of known polarized viewers as described further below with respect to FIGS. 2 and 3. In FIG. 1, an ad slot opportunity 104 on a Webpage 106 offered by a media property 102 is presented in an auction for an impression opportunity. In this example, an advertisement is to be placed in ad slot 104 on Webpage 106 to be viewed by a specific viewer 108. Media property 102 sends a bid request package 110 consisting of viewer identification information for viewer 108 and criteria specific to ad slot 104. This bid request package is received on one or more servers 112 where the demand-side platform 114 operates, and this information is processed thereon. Subsequently, if the impression opportunity fits the targeting criteria of one or more advertiser clients 116, the demand-side platform responds with a bid response 118 which includes the advertisement itself, as well as a bid price.

In some embodiments of the invention, this particular impression opportunity may fit with a previously defined advertising campaign for one or more advertiser clients 116. For such campaigns, the demand-side platform 114 may have previously provided a price quote 122 for such campaign. In this case, instead of simply quoting impressions to be purchased, the campaign may be quoted in terms of GRP's delivered. This, in effect, guarantees viewing reach for specific targeting criteria. To receive a campaign price quote 122, an advertiser client 116 would have previously delivered to the demand-side platform a request for a quotation that includes an information package 120. The information package 120 includes, for example GRP's desired, campaign targeting parameters, and campaign runtime.

FIG. 2 is a block diagram that shows system components and data flow for Website and viewer polarization profiling, as well as GRP prediction and quoting according to the invention. In FIG. 2, a polarization profiling engine 202 operates on one or more processors and/or servers 112 according to the flow shown in FIG. 3. A database of polarized MPs 206 is first created based on the activity of viewers in a truth set 204. Viewers in the truth set 204 are characterized at least by gender, although they may also be characterized, e.g. by age, geographic location (“geos”), and other characteristics. Subsequently, a database of known polarized viewers 208 is created by the polarization profiling engine. Optionally, look-alike viewers may be categorized, as described herein, and added to the database of known viewers based on a comparison with known polarized viewers.

Subsequently, an advertiser client 210 may supply an information package 120 to the demand-side platform that includes a desired campaign runtime 212, a quantity of GRPs desired 214 for a campaign, and targeting characteristics 216 for the campaign. In response, a GRP prediction and quoting engine 220 that operates on one or more processors and/or servers 112 provides a GRP price quote 222 to an advertiser client 210. If the advertiser client finds the quote acceptable, the advertiser client normally engages with the demand-side platform to execute the campaign. When the campaign is completed, a package of historical campaign data 224 is obtained from Nielsen to validate the reach of the campaign.

As shown in flowchart 300 of FIG. 3, a first phase of the polarization characterization process involves a determination 330 of polarization characteristics for different MPs, e.g. typically Websites, that viewers may visit. Within this process, a first step establishes 302 a Truth Set of viewers and/or cookies by purchasing or otherwise acquiring data. A truth set is a database of specific viewers that includes, for example, their cookies and known characteristics for those viewers, such as age and gender. Once a truth set is available, it is then characterized for one or more Viewer Characteristics (VCs) per step S302.

Subsequently, per step S304, records of past Internet visits are searched and analyzed relative to the behavior of different viewers, going back in time by a specified number of months. Where a viewer in the records of past Internet visits belongs to the truth set, counters are incremented for each VC, e.g. gender, age group, etc., for each Media Property (MP), e.g. Site/domain, App ID, Game ID, etc., visited by the viewer. Once this process is finished, at least an empirical male/female frequency or probability has been established for every Media Property matched by at least one viewer and/or cookie from the truth set. In a similar way, each MP is also profiled for polarization with respect to viewers and/or visitors in different age brackets and any other VC category of interest.

With respect to gender, the gender statistical distribution is expected to be approximately 50:50 in the general Internet populace and, therefore, it is appropriate to normalize 306 distributions for each media property to account for any biases in the Truth Set distribution. To accomplish this, the gains to be applied to the Male and Female probabilities are computed as follows:

First, the number of viewers and/or cookies representing the Least Frequent Gender is set to be equal to the minimum number of either the Females in the Truth Set or the Males in the Truth Set. Then, a gain factor for each gender subset is calculated as follows:

Gain for Females=Least Frequent Gender/Females in Truth Set

Gain for Males=Least Frequent Gender/Males in Truth Set

The Unbiased Probability (“P”) for each gender at each media property (MP) is then determined (S308) as follows:

P(Female) for MP=Gain for Females*(Female Count for MP/Total Cookies at MP)

P(Male) for MP=Gain for Males*(Male Count for MP/Total Cookies at MP)

At this point, a database of polarized MPs has been created for each MP, where a polarization probability exists for each VC for which a characterization determination was performed with respect to the truth set. In an embodiment of the invention, GRP prediction and quoting uses this polarized MP database to calculate predicted GRP reach for a proposed campaign and to create a price quote for that campaign.

After an initial classification for polarized Websites using the truth set per FIG. 3, MPs may be further bucketed or classified each time a viewer in the truth set visits a Website, thus further enhancing the classification accuracy for any MP so visited.

### Polarization Profiling of Viewers

In predicting the results of a campaign it can be especially useful if the polarization of a potential viewer is understood when impression opportunities arise on a particular MP for that viewer. As such, it is useful to profile and classify unknown viewers with respect to VCs and to build a database of known polarized viewers that includes a probability of polarization with respect to different VCs for each polarized viewer.

Choosing a set of media properties (MPs) that allow the profiling of viewers and/or cookies that are not members of the truth set is done as follows:

Per step S308, all MPs are identified whose unbiased distributions are highly polarized towards Male or Female, or towards any other VCs being analyzed These MPs are rated as polarized. Stereotypical examples of Websites (MPs) exhibiting extreme degrees of polarization include for instance Sports-oriented for Males, and Fashion-oriented for Females. To accomplish this, a threshold is applied to the dominant gender, i.e. if the value of:

Max(P(Female),P(Male))

is greater than a predefined threshold, for example 0.80, then the MP is added to the Polarized Set with respect to the VC being analyzed, e.g. gender. This typically adds 100s to 1000s of media properties to a database of polarized MPs, with varying levels of traffic being categorized as polarized or not. In all cases, the polarization probability for an MP with respect to each VC is recorded, and this is useful in some embodiments of the invention for GRP estimation and quoting when not all sites chosen by an advertiser and/or client are highly polarized, and some sites with only moderate polarization must be included to fulfill the reach and/or time frame requirements of a campaign.

To categorize 340 any unknown viewer and/or cookie for VC polarization probability, for example gender (Male or Female), an exemplary embodiment of the invention keeps a running probability for each of them. By default the distribution is set at:

P(Female)=0.5|P(Male)=0.5

Each time that a cookie and/or viewer is seen viewing a polarized MP, the probabilities for that cookie and/or viewer are updated (S310) as follows (with the assumption that each auction is statistically independent):

P(Male)′=P(Male)*Polarized Site P(Male)

P(Female)′=P(Female)*Polarized Site P(Female)

where the:

Denominator for Normalization=P(Male)′+P(Female)′

Therefore:

P(Male)′=P(Male)′/Denominator for Normalization

P(Female)′=P(Female)′/Denominator for Normalization

which guarantees that the definition of probability holds, that is:

P(Male)′+P(Female)′=1

Each time that a cookie and/or viewer is seen visiting a polarized site, the probabilities are re-adjusted. Multiple hits on highly polarized sites of the same orientation rapidly result in gender assessments with probability generally exceeding 0.95.

Finally, any time it becomes useful to delineate a male or female segment from the database of classified polarized viewers and/or cookies, all members are analyzed and their probabilities for a particular VC are compared (S312) with a threshold for whichever direction is dominant for the particular VC, for example in the case of gender, Max(P(Female), P(Male)).

The chosen threshold value corresponds directly to the predicted overall accuracy for the segment, while the expected accuracy for gender (Male and Female) for example, is equal to the mean probability across all chosen viewers and/or cookies. An example of a threshold value is 0.92, but this value can be lowered to increase the size of the pool (reach) traded off against accuracy.

For a cookie and/or viewer and a particular VC, if the polarization probability is greater (S314) than the threshold value, then that C\cookie and/or viewer is recorded (S316) as polarized for the specific VC, e.g. gender, age group, etc. The specific probability value is also optionally recorded in the known viewer database. If, on the other hand, that cookie and/or viewer has a polarization probability that is less than the threshold value, then the probability value for that cookie and/or viewer may be still optionally recorded (S318) for the specific VC, e.g. gender, age group, etc., in the known viewer database. After either of steps S316 or S318, the next cookie and/or viewer (S320) is analyzed per step S310.

It is preferable that multiple cookie and/or site hits are not recorded, so that hitting the same site again and again does not change a viewer's probabilities. It is significant that only highly polarized MPs are considered as polarized. Using all probabilities would result in a per-cookie assessment in which the biases would be drowned out by the more frequently seen sites that are not polarized.

Once a set of viewers and/or cookies has been classified with high accuracy, the set can be used to profile MPs for polarity in a manner similar to that of the truth set per the process of FIG. 3. In this case however, the analysis must take into account the probability for each VC for a particular viewer and/or cookie being used, unlike the truth set each VC for a particular polarized viewer which is typically less than 100% probable.

Also, the approach can extend beyond just sites, apps, and games to partial URLs, verticals, and any other attributes that are available in auction protocols. Furthermore, with the appropriate truth set, classification can be extended to age brackets, marital status, children in household, etc.

Embodiments of the invention include, for example, situations where the number of classified viewers and/or cookies in the known viewer database is increased by adding look-alikes. Here, cookies and/or viewers that did not hit any polarized sites are classified based on similar behavior to classified cookies, where the classified cookies have a probability established for different VCs.

### Determining Look-Alike Viewers Based on Polarized Viewers

Look-alike modeling has been used for some time in advertising campaigns and is currently used in electronic and online advertising. In general, look-alike modeling includes selection of a trait or target segment and data sources for analysis, including a baseline population database for comparison. The analysis looks for viewers in the data sources that are identical or similar to viewers in the baseline population with respect to the selected trait or target segment. Newly discovered traits are ranked in order of influence or desirability. The ranking may be a number between, for instance, 0 to 1. Viewers who rank closer to 1 are more like the audience in the baseline population.

Heavily weighted traits are valuable because they represent new, unique viewers who may behave similarly to the established audience represented in the baseline population. The result is a database of look-alike Viewers who have characteristics similar to those in a well characterized baseline population. In embodiments of the invention, the baseline population is typically the database of known, polarized viewers. Adding look-alike viewers to the database of known viewers enables larger campaigns to be addressed where the database of known polarized viewers alone is not large enough to meet the campaign requirements in terms of reach and/or run time. Also, because a look-alike viewer has not been profiled by the method described above in connection with FIG. 3, the polarization probability for a look-alike viewer may be down-graded relative to the known polarized viewers that were used to determine the look-alike viewer. For example, if the male gender assessment for known male polarized viewers is 95%, then the gender assessment for a look-alike polarized viewers might be 80%.

### Computer Implementation

FIG. 4 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e. software, 1626 embodying any one, or all, of the methodologies described herein. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC). Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for profiling electronic media properties and viewers with respect to polarization, comprising:
a processor accessing a truth set database of viewers having known viewer characteristics and cookies;
said processor analyzing behavior of viewers in said truth set and recording said viewers' viewing activity with respect to different media properties;
said processor rating each media property visited by viewers in said truth set according to a degree of polarity with respect to characteristics of said viewers in the truth set;
based upon said rating, said processor establishing a set of polarized media properties;
said processor analyzing viewing activity of viewers who are not within said truth set with respect to media viewing activity respective of said set of polarized media properties;
said processor assigning a degree of polarization to said viewers who are not within said truth set with respect to media viewing activity respective of said set of polarized media properties visited by said viewers who are not within said truth set; and
said processor placing viewers who are not within said truth set to whom a degree of polarization is assigned in a database of polarized viewers.

2. The method of claim 1, said analyzing behavior of viewers in said truth set further comprising:
analyzing past viewer behavior that is recorded in a historical database.

3. The method of claim 1, said analyzing behavior of viewers in said truth set further comprising:
analyzing current viewing behavior at the time that viewers in the truth set are presented with a viewing opportunity.

4. The method of claim 1, said analyzing the behavior of viewers in the truth set, and recording their viewing activity with respect to different media properties further comprising:
incrementing counters for a viewer characteristic category with respect to a media property.

5. The method of claim 1, further comprising:
when analyzing behavior of viewers in said truth set, normalizing one or more viewer characteristic distributions to account for bias in a truth set distribution.

6. The method of claim 1, said assigning a degree of polarity to a viewer who is not in said truth set visiting a polarized media property with respect to media viewing activity respective of said set of polarized media properties visited by said viewers who are not within said truth set further comprising:
increasing a polarization probability number for said viewer.

7. The method of claim 6, further comprising:
determining whether said polarization probability number for said viewer is greater than a probability threshold; and
recording said viewer as a polarized viewer when said polarization probability number for said viewer is greater than said probability threshold.

8. The method of claim 1, further comprising:
adding viewers in said database of polarized viewers who have been classified with an accuracy greater than a pre-determined threshold with respect to polarity to said truth set; and
using a resulting revised truth set as said truth set database of viewers with known viewer characteristics and cookies.

9. The method of claim 1, wherein the viewer characteristics comprise any of age and gender.

10. The method of claim 1, further comprising:
adding look-alike viewers to said database of polarized viewers to enable larger campaigns to be addressed, where said database of polarized viewers alone is not large enough to meet campaign requirements in terms of reach and/or run time.

11. The method of claim 10, further comprising:
downgrading polarization probability for a look-alike viewer relative to polarized viewers who were used to determine said look-alike viewer.

12. A computer implemented method for profiling electronic media properties with respect to polarization, comprising:
a processor accessing a truth set database of viewers having known viewer characteristics and cookies;
said processor analyzing behavior of viewers in said truth set and recording said viewers' viewing activity with respect to different media properties;
said processor rating each media property visited by viewers in said truth set according to a degree of polarization probability regarding characteristics of said viewers in said truth set; and
based upon said rating, said processor establishing a set of polarized media properties.

13. The method of claim 12, said analyzing behavior of said viewers in said truth set further comprising:
analyzing past viewer behavior that is recorded in a historical database.

14. The method of claim 12, said analyzing behavior of said viewers in said truth set further comprising:
analyzing current viewing behavior at the time that viewers in the truth set are presented with a viewing opportunity.

15. The method of claim 12, said analyzing the behavior of viewers in the truth set, and recording their viewing activity with respect to different media properties further comprising:
incrementing counters for a viewer characteristic category with respect to a media property.

16. The method of claim 12, further comprising:
when analyzing behavior of viewers in said truth set, normalizing one or more viewer characteristic distributions to account for bias in a truth set distribution.

17. The method of claim 12, wherein the viewer characteristics comprise any of age and gender.

18. An apparatus for profiling electronic media properties and viewers with respect to polarization, comprising:
a processor configured for accessing a truth set database of viewers having known viewer characteristics and cookies;
said processor configured for analyzing behavior of viewers in said truth set and recording said viewers' viewing activity with respect to different media properties;
said processor configured for rating each media property visited by viewers in said truth set according to a degree of polarity with respect to characteristics of said viewers in the truth set;
based upon said rating, said processor configured for establishing a set of polarized media properties;
said processor configured for analyzing viewing activity of viewers who are not within said truth set with respect to media viewing activity respective of said set of polarized media properties;
said processor configured for assigning a degree of polarization to said viewers who are not within said truth set with respect to media viewing activity respective of said set of polarized media properties visited by said viewers who are not within said truth set; and
said processor configured for placing viewers who are not within said truth set to whom a degree of polarization is assigned in a database of polarized viewers.

19. The apparatus of claim 18, said analyzing behavior of viewers in said truth set further comprising:
said processor configured for analyzing past viewer behavior that is recorded in a historical database.

20. The apparatus of claim 18, said analyzing behavior of viewers in said truth set further comprising:
analyzing current viewing behavior at the time that viewers in the truth set are presented with a viewing opportunity.

21. The apparatus of claim 18, said analyzing the behavior of viewers in the truth set, and recording their viewing activity with respect to different media properties further comprising:
said processor configured for incrementing counters for a viewer characteristic category with respect to a media property.

22. The apparatus of claim 18, further comprising:
when analyzing behavior of viewers in said truth set, said processor configured for normalizing one or more viewer characteristic distributions to account for bias in a truth set distribution.

23. The apparatus of claim 18, said assigning a degree of polarity to a viewer who is not in said truth set visiting a polarized media property with respect to media viewing activity respective of said set of polarized media properties visited by said viewers who are not within said truth set further comprising:
said processor configured for increasing a polarization probability number for said viewer.

24. The apparatus of claim 23, further comprising:
said processor configured for determining whether said polarization probability number for said viewer is greater than a probability threshold; and
said processor configured for recording said viewer as a polarized viewer when said polarization probability number for said viewer is greater than said probability threshold.

25. The apparatus of claim 18, further comprising:
said processor configured for adding viewers in said database of polarized viewers who have been classified with an accuracy greater than a pre-determined threshold with respect to polarity to said truth set; and
said processor configured for using a resulting revised truth set as said truth set database of viewers with known viewer characteristics and cookies.

26. The apparatus of claim 18, wherein the viewer characteristics comprise any of age and gender.

27. The apparatus of claim 18, further comprising:
said processor configured for adding look-alike viewers to said database of polarized viewers to enable larger campaigns to be addressed, where said database of polarized viewers alone is not large enough to meet campaign requirements in terms of reach and/or run time.

28. The apparatus of claim 27, further comprising:
said processor configured for downgrading polarization probability for a look-alike viewer relative to polarized viewers who were used to determine said look-alike viewer.

29. An apparatus for profiling electronic media properties with respect to polarization, comprising:
a processor accessing a truth set database of viewers having known viewer characteristics and cookies;
said processor analyzing behavior of viewers in said truth set and recording said viewers' viewing activity with respect to different media properties;
said processor rating each media property visited by viewers in said truth set according to a degree of polarization probability regarding characteristics of said viewers in said truth set; and
based upon said rating, said processor establishing a set of polarized media properties.

30. The apparatus of claim 29, said analyzing behavior of said viewers in said truth set further comprising:
said processor configured for analyzing past viewer behavior that is recorded in a historical database.

31. The apparatus of claim 29, said analyzing behavior of said viewers in said truth set further comprising:
said processor configured for analyzing current viewing behavior at the time that viewers in the truth set are presented with a viewing opportunity.

32. The apparatus of claim 29, said analyzing the behavior of viewers in the truth set, and recording their viewing activity with respect to different media properties further comprising:
said processor configured for incrementing counters for a viewer characteristic category with respect to a media property.

33. The apparatus of claim 29, further comprising:
when analyzing behavior of viewers in said truth set, said processor configured for normalizing one or more viewer characteristic distributions to account for bias in a truth set distribution.

34. The apparatus of claim 29, wherein the viewer characteristics comprise any of age and gender.
